(19) United States
(12) Patent Application Publication
(10) Pub. No.: US 2024/0234831 A9
(43) Pub. Date: Jul. 11, 2024

(54) ELECTRODE-SEPARATOR INTEGRATED ASSEMBLIES AND LITHIUM-METAL ELECTROCHEMICAL CELLS USING SUCH ASSEMBLIES

(71) Applicant: Cuberg, Inc., San Leandro, CA (US)

(72) Inventor: Alun Thomas, San Leandro, CA (US)

(73) Assignee: Cuberg, Inc., San Leandro, CA (US)

(21) Appl. No.: 18/491,347

(22) Filed: Oct. 20, 2023

Related U.S. Application Data
(60) Provisional application No. 63/380,543, filed on Oct. 21, 2022.

(51) Int. Cl. H01M 10/0587; H01M 50/46; H01M 50/466; H01M 50/536

(52) U.S. Cl. CPC H01M 10/0587; H01M 50/461; H01M 50/466; H01M 50/536; H01M 10/052

(57) ABSTRACT

Described herein are electrode-separator integrated assemblies, lithium-metal electrochemical cells comprising such assemblies, and methods of fabricating such assemblies and cells. An assembly can be formed as one continuous structure comprising one type of electrodes (referred to as an assembly electrode) wrapping around multiple other-type electrodes (referred to as non-assembly electrodes). Either positive or negative electrodes can be assembly electrodes, i.e., parts of electrode-separator integrated assemblies. The assembly also comprises a first separator portion and a second separator portion such that the assembly electrode is positioned between the two separator portions. The separator portions can be adhered to the assembly electrode. The separator portions can be independent separate sheets or parts of a single monolithic sheet wrapping around the inner edges of the assembly electrode. A portion of the assembly electrode extends from the separator portions for making electrical connections to other electrodes and or cell tabs.

### CROSS-REFERENCE TO RELATED APPLICATIONS

This application claims the benefit under 35 U.S.C. § 119(e) of US Provisional Patent Application 63/380,543 filed on 2022-1021, which is incorporated herein by reference in its entirety for all purposes.

### BACKGROUND

Li-ion batteries are widely used for various applications, as small as medical devices or cell phones and as large as electric vehicles or aircraft. Lithium metal batteries represent a different battery type and are distinct from Li-ion batteries. Li-ion batteries or, more specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

Typically, Li-metal cells utilize solid or polymer electrolytes that provide support and maintain the alignment between the positive and negative electrodes. However, a specific subclass of Li-metal cells utilizes liquid electrolytes, similar to Li-ion cells. Unlike solid or polymer electrolytes, liquid electrolytes can not provide such support functions. A liquid electrolyte soaks a porous separator, which is positioned between the positive and negative electrodes, thereby providing ionic conductivity between the electrodes. The electrode support depends on the cell design. For example, in wound cells, most of the support is provided by friction/compression (among the electrodes and separator sheets). In stacked cells, the friction/compression support between the electrodes can be diminished. However, additional support can be provided by the tabs that are used for external connections to the electrodes.

It should be noted that the electrode support in any cell type is critical as it ensures the alignment of positive and negative electrodes. Specifically, this alignment provides that all (or at least most) lithium ions released from the positive electrode (during the cell charging) are captured by the corresponding negative electrode. Without the alignment, lithium can be plated in undesirable locations causing internal cell shorts and potentially catastrophic failures.

What is needed are new methods and devices for aligning positive and negative electrodes in batteries.

### SUMMARY

Described herein are electrode-separator integrated assemblies, lithium-metal electrochemical cells comprising such assemblies, and methods of fabricating such assemblies and cells. An assembly can be formed as one continuous structure comprising one type of electrode (referred to as an assembly electrode) wrapping around multiple other-type electrodes (referred to as non-assembly electrodes). Either positive or negative electrodes can be assembly electrodes, i.e., being parts of electrode-separator integrated assemblies. The assembly also comprises a first separator portion and a second separator portion such that the assembly electrode is positioned between the two separator portions. The separator portions can be adhered to the assembly electrode. The separator portions can be independent separate sheets or parts of a single monolithic sheet wrapping around the inner edges of the assembly electrode. A portion of the assembly electrode extends from the separator portions for making electrical connections to other electrodes and or cell tabs.

These and other embodiments are described further below with reference to the figures.

### BRIEF DESCRIPTION OF THE DRAWINGS

FIG. 1A is a schematic top view of a stacked electrochemical cell illustrating the relative position and alignment of the electrodes and separator in the cell, in accordance with some examples.

FIG. 1B is a partial cross-sectional view of the stacked electrochemical cell in FIG. 1A, illustrating various offsets between the electrodes and separator, in accordance with some examples.

FIG. 1C is a schematic top view of a stacked electrochemical cell with electrode tabs positioned on opposite sides of the cell, in accordance with some examples.

FIG. 2A is a schematic cross-sectional view of a lithium-metal electrochemical cell comprising multiple non-assembly electrodes and an electrode-separator integrated assembly, comprising two separator portions and an assembly electrode positioned between the two separator portions and wrapping around the multiple non-assembly electrodes, in accordance with some examples.

FIG. 2B is a schematic cross-sectional view of a specific example of the lithium-metal electrochemical cell in FIG. 2A, where the non-assembly electrodes are positive electrodes and where the assembly electrode is a single negative lithium-metal electrode.

FIG. 3A is a partial cross-sectional view of an electrode-separator integrated assembly comprising two separator portions and a negative electrode, stacked between these two separator portions, in accordance with some examples.

FIG. 3B is a partial cross-sectional view of an electrode-separator integrated assembly comprising a separator sheet wrapping around the inner edge of a negative electrode, in accordance with some examples.

FIG. 3C is a top schematic view of the electrode-separator integrated assembly in FIG. 3B, in accordance with some examples.

FIG. 4A is a partial cross-sectional view of an electrode-separator integrated assembly comprising two separator portions and a positive electrode, stacked between these two separator portions, in accordance with some examples.

FIG. 4B is a partial cross-sectional view of an electrode-separator integrated assembly comprising a separator sheet wrapping around the inner edge of a positive electrode, in accordance with some examples.

FIG. 4C is a top schematic view of the electrode-separator integrated assembly in FIG. 4B, in accordance with some examples.

FIGS. 5A-5D are different schematic views of a stack formed by two electrodes with a separator folded around these electrodes, in accordance with some examples.

FIGS. 6A-6D are different schematic views of a stack formed by two electrodes in which one electrode is a part of an electrode-separator integrated assembly together with a separator, in accordance with some examples.

FIGS. 7A-7D are different schematic views of a stack formed by two electrodes in which one electrode is a part of an electrode-separator integrated assembly together with a separator that has two types of folds, in accordance with some examples.

FIG. 8 is a cross-sectional expanded view of a lithium-metal electrochemical cell by stacking positive electrodes with an electrode-separator integrated comprising a negative electrode and forming connections to positive and negative tabs, in accordance with some examples.

FIG. 9 is a process flowchart corresponding to a method of fabricating a cell in which the negative electrode is a part of an electrode-separator integrated assembly together with a separator, in accordance with some examples.

FIGS. 10A-10D are schematic illustrations of different stages during the fabrication of a cell in which the negative electrode is a part of an electrode-separator integrated assembly together with a separator, in accordance with some examples.

FIG. 11 is a block diagram of an electric vehicle using a cell in which at least one electrode is a part of an electrode-separator integrated assembly together with a separator, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### INTRODUCTION

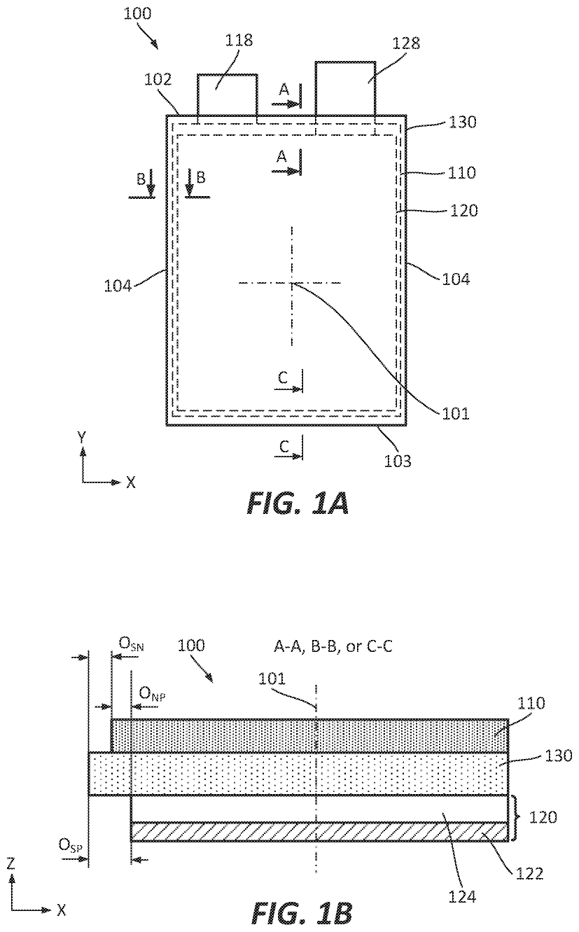

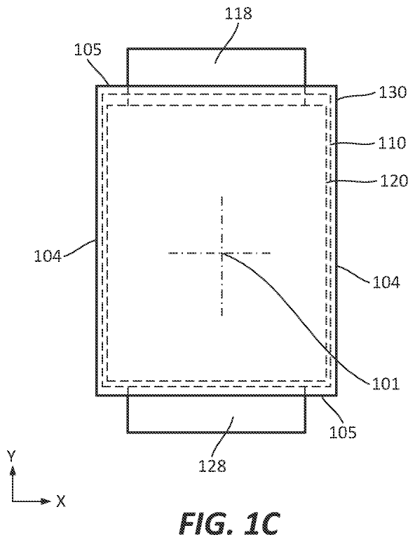

Electrode alignment is critical to the performance and safety of electrochemical cells. Specifically, the footprint of a negative active material layer has to cover the entire footprint of the corresponding positive active material layer to ensure that, during the cell charging, all lithium ions released by the positive active material layer are directed to the negative active material layer and do not form lithium deposits elsewhere within the cell. This footprint alignment is schematically shown in FIGS. 1A and 18. Specifically, FIG. 1A is a schematic top view of a stacked electrochemical cell illustrating the relative positions of negative electrode 110, positive electrode 120, and separator 130. In this example, both negative tab 118 and positive tab 128 extend from the side of the stack, which may be referred to as two-tab edge 102. Opposite of two-tab edge 102 is a no-tab edge 103. Side edges 104 extend between two-tab edge 102 and no-tab edge 103.

FIG. 18 is a schematic cross-sectional view of one edge of the stacked electrochemical cell in FIG. 1A, which could be either two-tab edge 102, side edge 104, or no-tab edge 103. Negative electrode 110 extends past the footprint of positive electrode 120 as reflected by the negative-positive offset (O_{NP}). This target offset depends on the alignment precision and other factors and can be between 0.5 millimeters and 3 millimeters, at least in conventional stacks. Furthermore, separator 130 protrudes past negative electrode 110, which may be referred to as the separator-positive offset (O_{SN}) and which can be between 0.5 millimeters and 3 millimeters. Similarly, separator 130 protrudes past positive electrode 120, which may be referred to as the separator-positive offset (O_{SP}) and which can be between 0.5 millimeters and 3 millimeters. These separator offsets ensure that negative electrode 110 and positive electrode 120 do not form direct electrical connections along the edges. Also, these separator offsets ensure that negative tab 118 does not come in contact with positive electrode 120 (along two-tab edge 102) while positive tab 128 does not come in contact with negative electrode 110. It should be noted that all offsets listed above occupy the space inside the battery without contributing to the battery capacity, which reduces the volumetric capacity of the battery. As such, reducing these offsets is highly desirable.

FIG. 1C illustrates another example of a stacked electrochemical cell. In this example, negative tab 118 and positive tab 128 extend from different sides of the stack, each of which may be referred to as one-tab edge 105. Side edges 104 extend between the two one-tab edges 105. The issues with the electrode and separate offsets are generally the same in this example as in the previous example described above with reference to FIGS. 1A and 18.

However, achieving this precise electrode alignment can be difficult, especially in stacked cells and at high production speeds. For example, once an electrode is added to a stack and aligned, stack handling operations and even cell handling operations (e.g., post-fabrication) can cause movement and potential misalignment of this electrode. The primary support of this electrode in the stack is provided by its current transferring tab (e.g., welded to other tabs after stacking) and friction between this electrode and adjacent separator layers. In some examples, the position and size of this tab are not ideally positioned for maintaining electrode alignment (e.g., relative to the overall size of the electrode). For example, it may be difficult to maintain the alignment of a long electrode with a single tab positioned on the short side of this electrode. Furthermore, the friction between this electrode and adjacent separator layers can be minimal during some cell fabrication steps and even post-fabrication (e.g., standalone pouch cells).

One difficulty with the electrode alignment results from each electrode being separated from adjacent electrodes by separator sheets such that the edges of these separator sheets extend past the edges of these electrodes as, e.g., is schematically shown in FIG. 1B. This edge offset is needed to prevent electrical shorts between positive and negative electrodes as described below. As such, the electrode edges and corners are mostly not accessible for alignment. The only electrode components extending past the separator edges are current transferring tabs as, e.g., is schematically shown in FIGS. 1A and 1C. Additional difficulties come from the high-speed nature of various operations (e.g., stacking), the inherent variability of dimensions (e.g., thickness) of incoming components, the fragility of electrodes, and other factors.

It should be noted that sheet-to-sheet alignment (i.e., the alignment of two adjacent sheets) is generally straightforward. However, when a stack includes multiple disjoined components (such as negative electrodes, positive electrodes, and separator sheets), the alignment of these components (often 50+ components) at the same time can be very challenging. Furthermore, when a continuous separator sheet is used in a Z-fold configuration, the control of the electrode dimensioning and alignment in all four corners is not possible. As such, the dimension validation is done via inferred distances which allow for some variability.

Electrode-separator integrated assemblies described herein address these alignment issues by integrating one type of electrode into these assemblies. The integrated electrode is referred to as an assembly electrode and could be either a negative electrode or a positive electrode. The other type of electrode is a non-assembly electrode. A stack could have multiple non-assembly electrodes with one assembly electrode winding around these non-assembly electrodes and providing support to the non-assembly electrodes. It should be noted that the electrode-separator integrated assembly is a single structure extending through or, more specifically, winding through the entire stack. This singularity helps to maintain the alignment in the stack, even though the electrode-separator integrated assembly may not be attached or bonded to the non-assembly electrodes. Additional alignment can be provided by electrode attachments to the external tabs and by the cell case enclosing the stack.

Lithium-Metal Electrochemical Cells with Electrode-Separator Integrated Assemblies

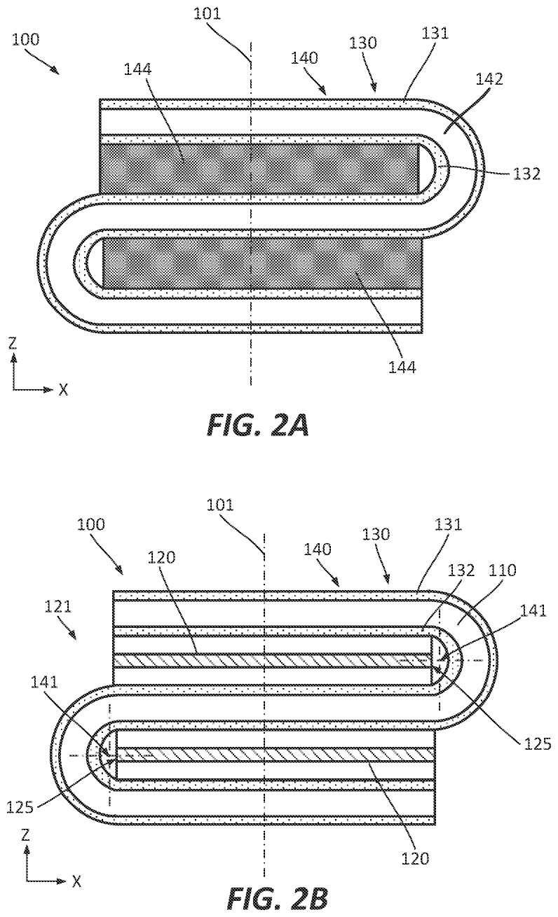

FIG. 2A is a schematic cross-sectional view of lithium-metal electrochemical cell 100 comprising assembly electrode 142 (forming electrode-separator integrated assembly 140) and non-assembly electrodes 144. As noted above, assembly electrode 142 can be either a positive electrode or a negative electrode. When assembly electrode 142 is positive, non-assembly electrode 144 is negative. Alternatively, when assembly electrode 142 is negative, non-assembly electrode 144 is positive, e.g., as shown in FIG. 2B which will now be described in more detail with reference to this figure. One having ordinary skill in the art would understand the features described below with reference to FIG. 2B can be adapted to an example where assembly electrode 142 is positive and non-assembly electrode 144 is negative.

Referring to FIG. 2B, in some examples, lithium-metal electrochemical cell 100 comprises multiple positive electrodes 120 and electrode-separator integrated assembly 140. Multiple positive electrodes 120 form a stack along stacking axis 101 of lithium-metal electrochemical cell 100. Electrode-separator integrated assembly 140 is formed as one continuous structure wrapping around multiple positive electrodes 120. While FIG. 2B illustrates only two positive electrodes 120, the stack (and lithium-metal electrochemical cell 100) can have any number of positive electrodes 120, e.g., one, two, three, four, or more.

Electrode-separator integrated assembly 140 comprises one (single) negative lithium-metal electrode 110 and separator 130. It should be noted that the same (single) electrode-separator integrated assembly 140 in the entire lithium-metal electrochemical cell 100. The assembly singularity helps to maintain the electrode orientation in the stack. The negative electrode singularity (within electrode-separator integrated assembly 140) helps to simplify the fabrication of electrode-separator integrated assembly 140 and also helps with current distribution between different stack layers. In other words, negative lithium-metal electrode 110 can provide the current flow among different layers in the stack, e.g., in addition to the external tabs.

Separator 130 comprises first separator portion 131 and second separator portion 132. Single negative lithium-metal electrode 110 is positioned between first separator portion 131 and second separator portion 132. Single negative lithium-metal electrode 110 is separated from each of multiple positive electrodes 120 by separator 130. For example, single negative lithium-metal electrode 110 is separated from one or more positive electrodes 120 by first separator portion 131 and is also separated from an additional one or more positive electrodes by second separator portion 132.

Referring to FIG. 2B, each adjacent pair of positive electrodes 120 (or, more specifically, each pair of two adjacent electrodes of multiple positive electrodes 120) has electrode-separator integrated assembly 140 extending between them (i.e., between these two adjacent positive electrodes). Furthermore, each positive electrode 120 has one edge 125 wrapped by electrode-separator integrated assembly 140.

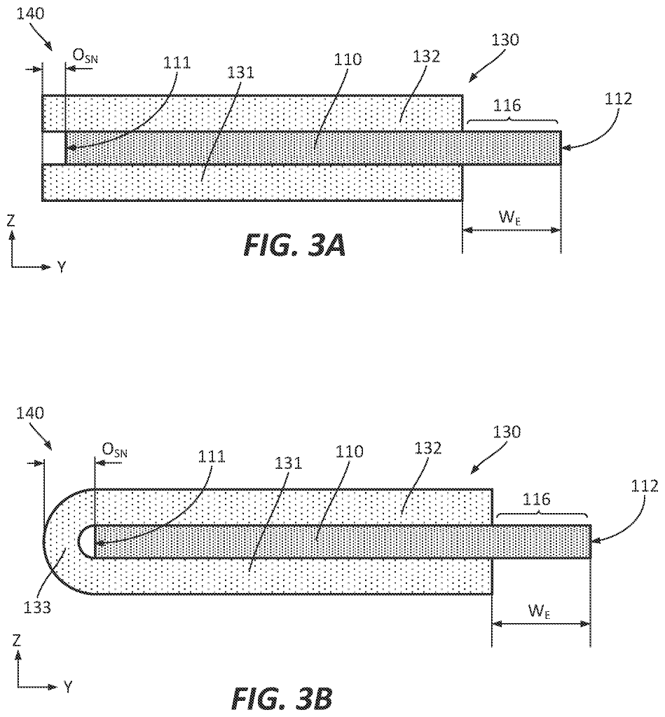

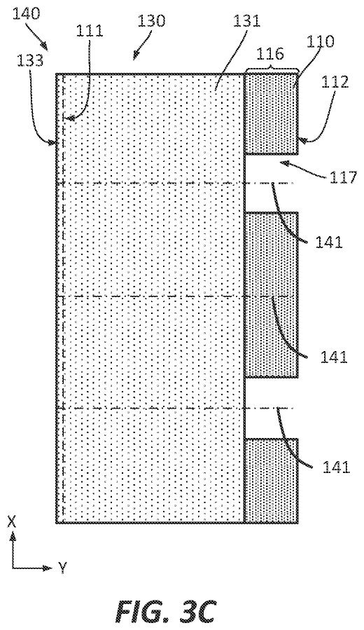

Referring to FIG. 3A, in some examples, first separator portion 131 and second separator portion 132 are separate disjoined components, e.g., separate sheets positioned on different sides of negative electrode 110. In these examples, inner edge 111 of negative electrode 110 can be offset (O_{SN}) from the edge of electrode-separator integrated assembly 140 formed by first separator portion 131 and second separator portion 132 thereby protecting inner edge 111 from contact with other components. However, inner edge 111 is accessible through the gap between first separator portion 131 and second separator portion 132, and this gap can be used for liquid electrolyte filling and other purposes.

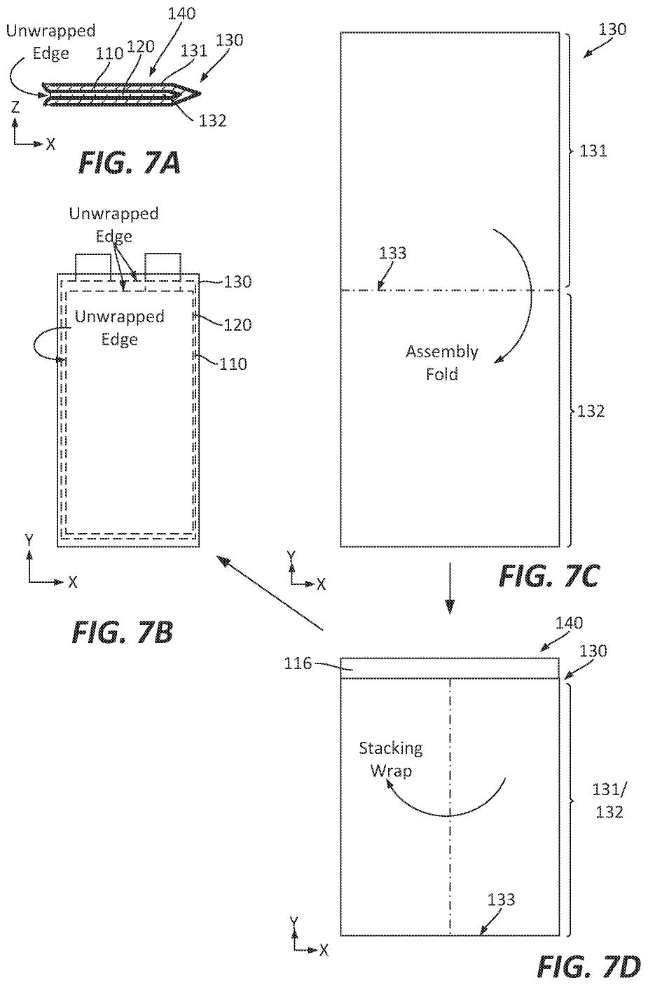

Alternatively, referring to FIG. 3B, in some examples, first separator portion 131 and second separator portion 132 are monolithic with each other. Specifically, first separator portion 131 and second separator portion 132 can be joined together and form separator edge 133 folded around inner edge 111 of single negative lithium-metal electrode 110. This may be referred to as a V-folded structure of separator 130. This type of structure may be formed by folding over a separator sheet around inner edge 111 of single negative lithium-metal electrode 110. This type of fold may be referred to as an assembly fold (further described below with reference to FIG. 7C) and should be distinguished from the stacking wrap (further described below with reference to FIG. 7D). Specifically, the assembly fold is performed along the axis that is perpendicular to the axis of the stacking wrap. Having a monolithic separator structure helps to maintain the alignment within electrode-separator integrated assembly 140 and reduces the number of components that are needed to form electrode-separator integrated assembly 140.

Returning to FIGS. 2B and 3C, in some examples, one edge 125 wrapped by electrode-separator integrated assembly 140 of each of multiple positive electrodes 120 is perpendicular to separator edge 133. Specifically, FIG. 2B illustrates wrapped edge 125 extending parallel and, in some examples, colinear with the wrapping axis 141. Wrapping axis 141 is also identified in FIG. 3C, which is a top view of electrode-separator integrated assembly 140 prior to wrapping. FIG. 3C shows multiple instances of the wrapping axis 141 (all of which are parallel to each other and offset by the width of positive electrodes 120) being perpendicular to separator edge 133 as well as to inner edge 111 of negative electrode 110.

In some examples, first separator portion 131 and second separator portion 132 are adhered to opposite sides of single negative lithium-metal electrode 110. For example, one or more of pressure and temperature can be used to laminate first separator portion 131 and second separator portion 132 to opposite sides of single negative lithium-metal electrode 110.

Returning to FIG. 2B, in some examples, one edge 125 wrapped by electrode-separator integrated assembly 140 of one of multiple positive electrodes 120 is positioned on opposite sides of the stack formed by multiple positive electrodes 120. In other words, wrapped edges and unwrapped edges alternate on each side of the stack, which helps to protect these edges from electrical shorts. This alternate position of the wrapped edges is a result of electrode-separator integrated assembly 140 wrapping around positive electrodes 120.

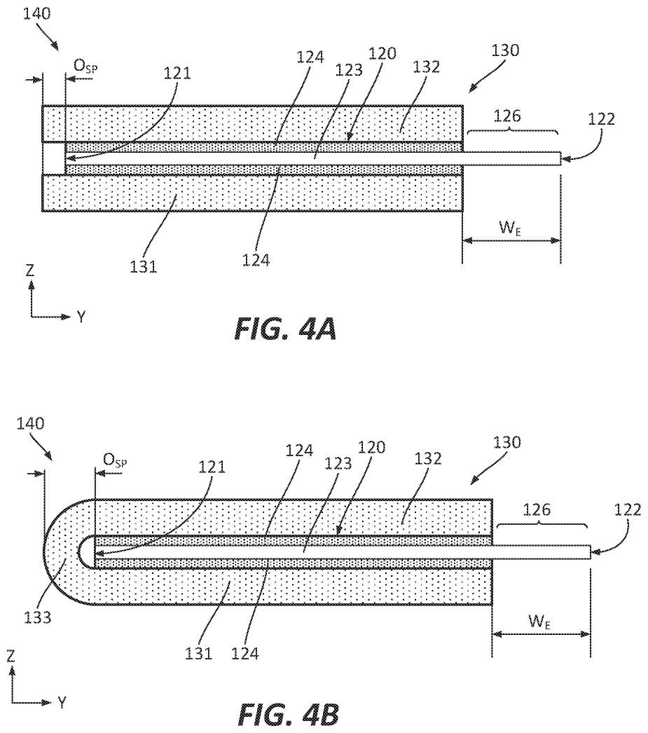

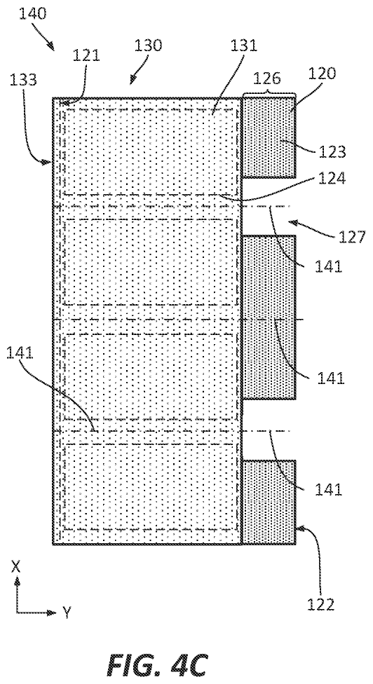

Referring to FIGS. 3A-3B and 4A, in some examples, single negative lithium-metal electrode 110 comprises outer edge 112, extending away from separator 130 and defining an unwrapped negative-electrode portion 116 and welded to a negative tab 118. The width (W E) of unwrapped negative-electrode portion 116 can be between 2 millimeters and 15 millimeters or, more specifically, between 5 millimeters and 10 millimeters. This unwrapped negative-electrode portion 116 can be used for forming electrical connections to negative lithium-metal electrode 110. In some examples, negative-electrode portion 116 comprises openings 117 extending between outer edge 112 and at least to separator 130 (and in some examples, past the edge of separator 130). After wrapping the electrode-separator integrated assembly 140 around positive electrodes 120, these openings 117 overlap with positive tabs extending to positive electrodes 120 thereby preventing shorts between positive electrodes 120 and negative lithium-metal electrode 110. In some examples, any two adjacent openings 117 are symmetrical with respect to wrapping axis 141 extending between these openings.

In some examples, negative lithium-metal electrode 110 has a uniform composition through an entire volume of single negative lithium-metal electrode 110. For example, negative lithium-metal electrode 110 can comprise predominantly lithium metal (e.g., more than 80% molar lithium metal, more than 90% molar lithium metal). In some examples, negative lithium-metal electrode 110 has a thickness of less than 100 micrometers, less than 75 micrometers, or even less than 50 micrometers.

As noted above, electrode-separator integrated assembly 140 can be formed using a negative electrode or a positive electrode. When electrode-separator integrated assembly 140 is formed by a negative electrode, a corresponding positive electrode is used as a standalone component (without being integrated with any separator components). Alternatively, when electrode-separator integrated assembly 140 is formed by a positive electrode, a corresponding negative electrode is used as a standalone component (without being integrated with any separator components). These examples will now be described with references to FIGS. 3A-3C and FIGS. 4A-4C.

Specifically, FIGS. 3A-3C illustrate different schematic views of electrode-separator integrated assembly 140 comprising single negative lithium-metal electrode 110. Some features of this electrode-separator integrated assembly 140 are described above with reference to lithium-metal electrochemical cell 100. Specifically, FIG. 3A illustrates an example where first separator portion 131 and second separator portion 132 are separate sheets, while FIG. 3B illustrates an example where first separator portion 131 and second separator portion 132 are parts of the same sheet wrapped around inner edge 111 of negative lithium-metal electrode 110. FIG. 3C is a top view of electrode-separator integrated assembly 140 shown in FIG. 3B, illustrating separator edge 133 offset relative to inner edge 111 of negative lithium-metal electrode 110. FIG. 3C also illustrates wrapping axis 141.

FIGS. 4A-4C illustrate different schematic views of electrode-separator integrated assembly 140 comprising single positive electrode 110. FIG. 4A illustrates an example where first separator portion 131 and second separator portion 132 are separate sheets with positive electrode 120 positioned between first separator portion 131 and second separator portion 132. FIG. 4B illustrates an example where first separator portion 131 and second separator portion 132 are parts of the same sheet wrapped around inner edge 121 of positive electrode 120. FIG. 4C is a top view of electrode-separator integrated assembly 140 shown in FIG. 4B, illustrating separator edge 133 being offset relative to inner edge 121 of positive electrode 120. FIG. 4C also illustrates wrapping axis 141.

It should be noted that while negative lithium-metal electrode 110 can be a monolithic uniform structure, positive electrode 120 can have different components. As shown in FIGS. 4A and 4B, positive electrode 120 comprises current collector 123 and two active material layers 124 disposed on each side of the current collector 123. Active material layers 124 can be fully covered by separator 130, while current collector 123 (uncoated with active material layers 124) can extend outside of separator 130, forming positive electrode extension 126, e.g., used to form electrical connections to positive electrode 120.

Referring to FIG. 4C, in some examples, the current collector 123 extends the entire length of electrode-separator integrated assembly 140 (in the X-direction), e.g., crossing over one or more instances of the wrapping axis 141. However, active material layers 124 are in the form of disjoined patches that are offset from each wrapping axis 141. These patches can be also offset from the edges of separator 130, such as separator edge 133 and another opposite edge. These offsets ensure that active material layers 124 fully overlap with negative lithium-metal electrodes 110. It should be noted that in these examples, lithium-metal electrochemical cell 100 comprises multiple negative lithium-metal electrodes 110 with electrode-separator integrated assembly 140 wrapping around these multiple negative lithium-metal electrodes 110. Furthermore, current collector 123 can comprise openings 127 extending between outer edge 122 and at least to separator 130 (and in some examples, past the edge of separator 130). After wrapping the electrode-separator integrated assembly 140 around negative lithium-metal electrodes 110, these openings 127 overlap with negative tabs extending to negative lithium-metal electrodes 110. In some examples, any two adjacent openings 127 are symmetrical with respect to wrapping axis 141 extending between these openings.

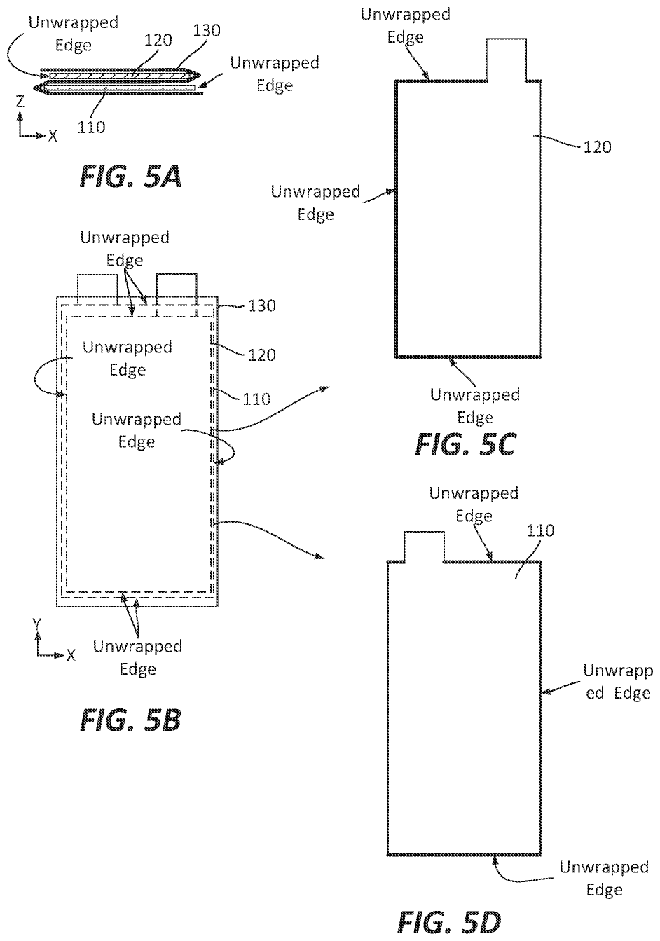

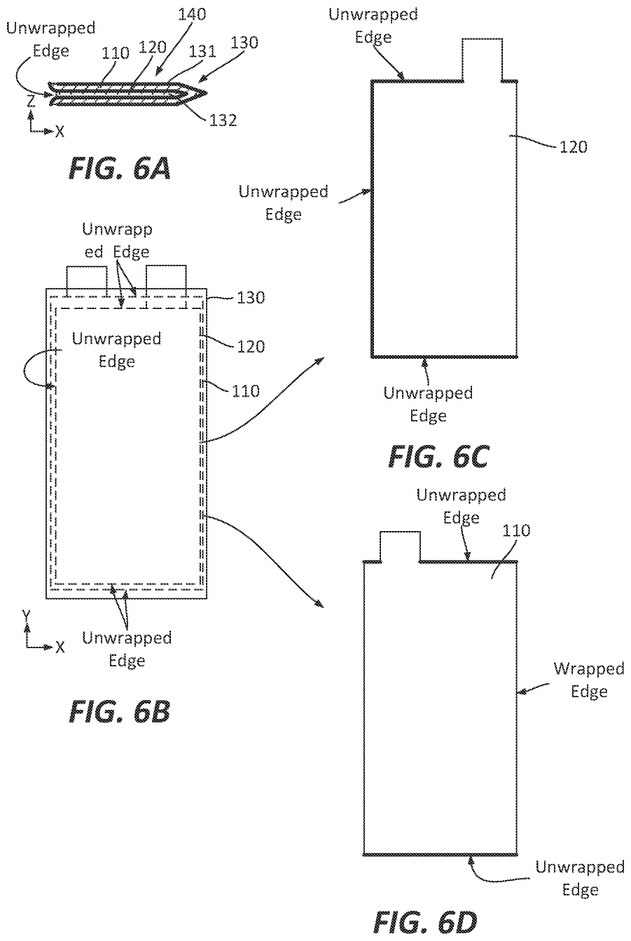

FIGS. 5A-5D, FIGS. 6A-6D, and FIGS. 7A-7D illustrate different examples of arranging positive and negative electrodes in a stack. Depending on the arrangement, different edges of positive and negative electrodes remain unwrapped and potentially open to contact with other components in the cell causing a short. FIGS. 5A-5D illustrate an example with Z-folded separator 130 wrapping around both positive electrode 120 and negative electrode 120. In this example, the three edges of each positive electrode 120 and the three edges of each negative electrode 110 remain unwrapped. FIGS. 6A-6D illustrate an example in which separator 130 and negative electrode 110 are integrated into electrode-separator integrated assembly 140, e.g., as described above with reference to FIG. 3A. In this example, the three edges of each positive electrode 120 still remain unwrapped, while only two edges (positioned on opposite sides along the Y-axis) of each negative electrode 110 remain unwrapped. It should be noted that if separator 130 and positive electrode 120 were integrated into electrode-separator integrated assembly 140, then the number of unwrapped edges would have switched, i.e., only two edges of each positive electrode 120 remain unwrapped, while three edges of each negative electrode 110 remain unwrapped.

FIGS. 7A-7D illustrate an example in which separator 130 and negative electrode 110 are not only integrated into electrode-separator integrated assembly 140 but also wrapped around inner edge 111 of negative electrode 110, e.g., as described above with reference to FIGS. 3B and 3C. In this example, separator 130 is first folded to form separator edge 133 as, e.g., is shown in FIGS. 7C and 7D. It should be noted that negative electrode 110 is now wrapped along separator edge 133 with only one side remaining unwrapped, e.g., the tab-containing edge.

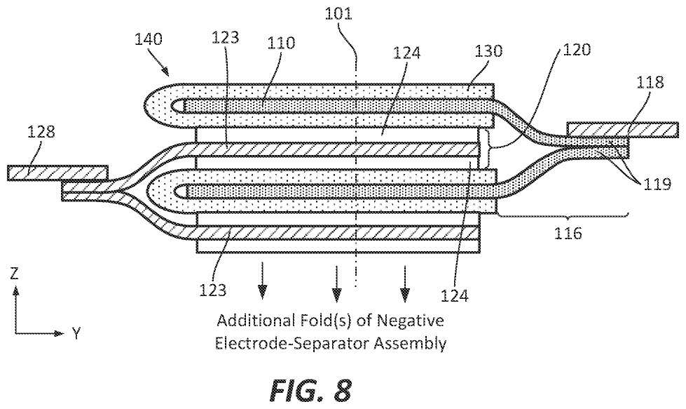

Referring to FIG. 8, in some examples, unwrapped negative-electrode portion 116 forms multiple independent unwrapped layers 119 stacked along a stacking axis 101, welded together, and welded to negative tab 118. Similar connections and welding can be performed with positive electrodes 120 or, more specifically, with positive current collectors 123.

### Methods of Fabricating Lithium-Metal Electrochemical Cells

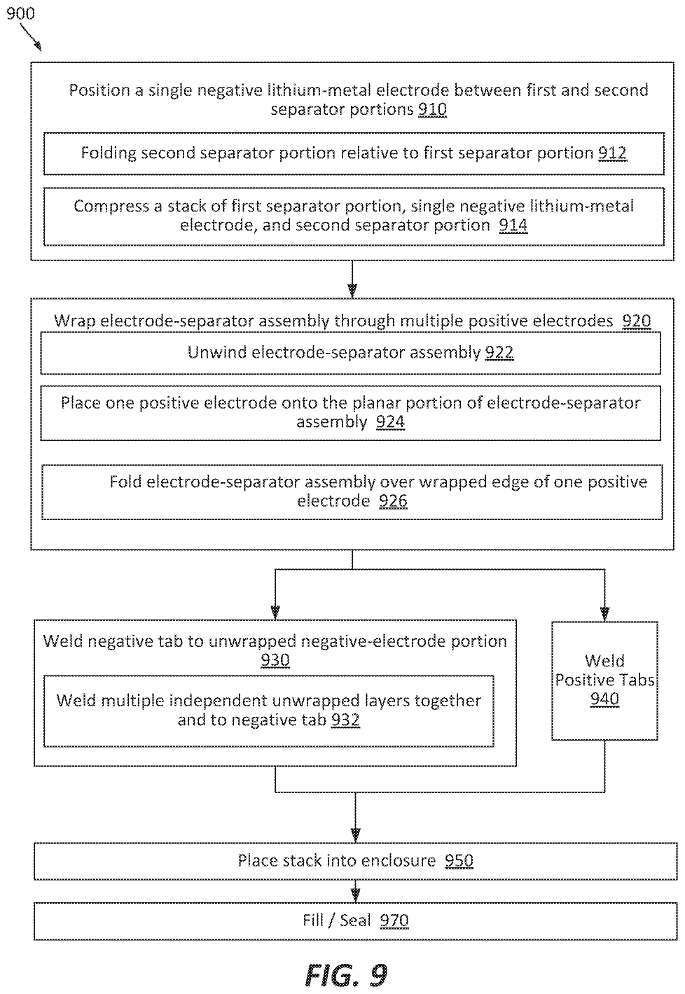

FIG. 9 is a process flowchart corresponding to method 900 of fabricating lithium-metal electrochemical cell 100, in accordance with some examples. Various examples of lithium-metal electrochemical cell 100 are described below. It should be noted that the following description of method 900 s directed to electrode-separator integrated assembly 140 comprising negative lithium-metal electrode 110. One having ordinary skill in the art would understand how this method can be adapted for an example where electrode-separator integrated assembly 140 comprises a positive electrode.

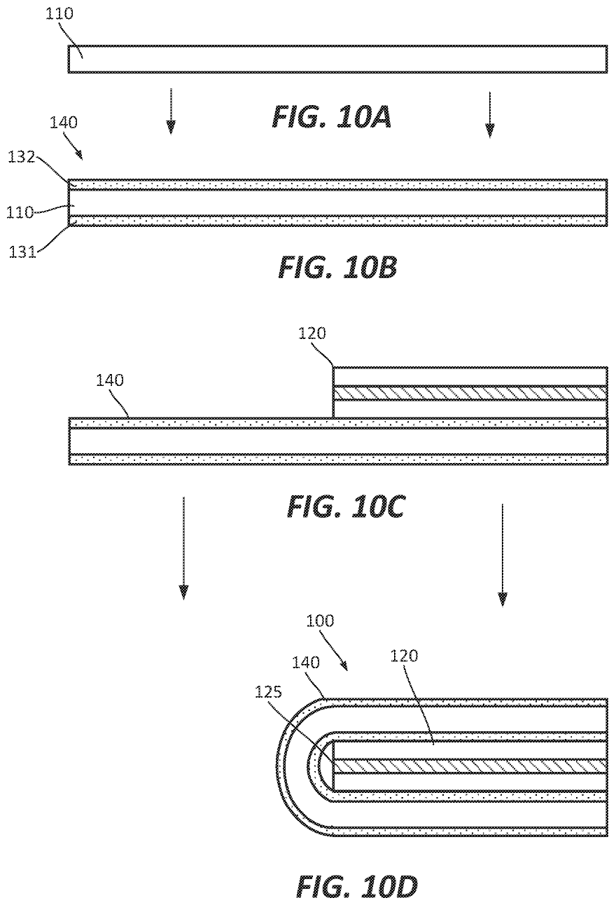

In some examples, method 900 comprises (block 910) positioning the single negative lithium-metal electrode 110 between first separator portion 131 and second separator portion 132 of separator 130 thereby forming electrode-separator integrated assembly 140, e.g., as schematically shown in FIGS. 10A and 10B.

In more specific examples, this positioning operation comprises (block 912) folding second separator portion 132 relative to first separator portion 131 thereby forming separator edge 133 wrapping around an inner edge 111 of single negative lithium-metal electrode 110 as, e.g., is schematically shown in FIG. 3C and further shown in FIGS. 10C and 10D.

In the same or other examples, the positioning operation comprises (block 914) compressing stack of first separator portion 131, single negative lithium-metal electrode 110, and second separator portion 132. This compressing operation can attach a single negative lithium-metal electrode 110 to each of the first separator portion 131 and second separator portion 132 such that the orientation of these components and preserved in electrode-separator integrated assembly 140. As such, electrode-separator integrated assembly 140 can be handled as a unit.

In some examples, method 900 comprises (block 920) wrapping electrode-separator integrated assembly 140 through multiple positive electrodes 120 while stacking multiple positive electrodes along stacking axis 101 of lithium-metal electrochemical cell 100. After this wrapping operation, each pair of two adjacent electrodes of multiple positive electrodes 120 has an electrode-separator integrated assembly 140 extending between these two adjacent electrodes. Furthermore, each positive electrode 120 has one edge 125 wrapped by electrode-separator integrated assembly 140. Furthermore, single negative lithium-metal electrode 110 is separated from each of multiple positive electrodes 120 by separator 130, e.g., either first separator portion 131 or second separator portion 132.

In some examples, the wrapping operation comprises (block 922) unwinding electrode-separator integrated assembly 140 forming a planar portion of electrode-separator integrated assembly 140. For example, electrode-separator integrated assembly 140 can be provided into a process as a roll. In more specific examples, electrode-separator integrated assembly 140 is provided into a continuous roll comprising multiple electrode-separator integrated assemblies.

The wrapping operation can further comprise (block 924) placing one of multiple positive electrodes 120 onto the planar portion of electrode-separator integrated assembly 140 and (block 926) folding electrode-separator integrated assembly 140 over wrapped edge 125 of each positive electrode 120 thereby forming an additional planar portion of electrode-separator integrated assembly 140.

In some examples, single negative lithium-metal electrode 110 comprises outer edge 112, extending away from separator 130 and defining unwrapped negative-electrode portion 116. Method 900 can comprise (block 930) welding negative tab 118 to unwrapped negative-electrode portion 116.

In more specific examples, unwrapped negative-electrode portion 116 forms multiple independent unwrapped layers 119 stacked along stacking axis 101. In these examples, the welding operation can comprise (block 932) welding together multiple independent unwrapped layers 119 and welding multiple independent unwrapped layers 119 to negative tab 118.

In some examples, method 900 also comprises (block 940) welding positive tabs, (block 950) placing the stack into an enclosed, and (block 970) filling the enclosure with liquid electrolyte followed by sealing.

### Application Examples

Lithium-metal electrochemical cell 100, described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles).

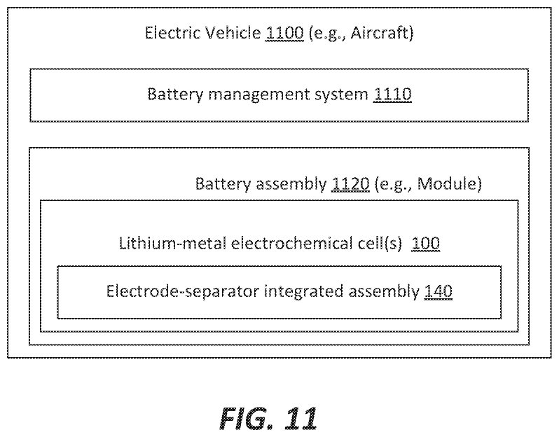

FIG. 11 is a block diagram of electric vehicle 1100 (e.g., aircraft) comprising battery assembly 1120 and batter management system 1110, receiving input (e.g., voltage, temperature) from battery assembly 1120 and controlling operations of battery assembly 1120 (e.g., charge/discharge rates, cutoff voltages). Battery assembly 1120 comprises one or more lithium-metal electrochemical cells 100 various examples of which are described above. Specifically, each lithium-metal electrochemical cell 100 comprises electrode-separator integrated assembly 140 formed by a single continuous electrode and two separator portions, positioned on different sides of this electrode.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A lithium-metal electrochemical cell comprising:
multiple positive electrodes forming a stack along a stacking axis of the lithium-metal electrochemical cell; and
an electrode-separator integrated assembly formed as one continuous structure wrapping around the multiple positive electrodes, wherein:
the electrode-separator integrated assembly comprises a single negative lithium-metal electrode and a separator comprising a first separator portion and a second separator portion such that the single negative lithium-metal electrode is positioned between the first separator portion and the second separator portion,
each pair of two adjacent electrodes of the multiple positive electrodes has the electrode-separator integrated assembly extending between the two adjacent electrodes,
each of the multiple positive electrodes has one edge wrapped by the electrode-separator integrated assembly, and
the single negative lithium-metal electrode is separated from each of the multiple positive electrodes by the separator.

2. The lithium-metal electrochemical cell of claim 1, wherein the first separator portion and the second separator portion are monolithic with each other joining together and forming a separator edge folded around an inner edge of the single negative lithium-metal electrode.

3. The lithium-metal electrochemical cell of claim 2, wherein the one edge wrapped by the electrode-separator integrated assembly of each of the multiple positive electrodes is perpendicular to the separator edge.

4. The lithium-metal electrochemical cell of claim 1, wherein the first separator portion and the second separator portion are two disjoined components.

5. The lithium-metal electrochemical cell of claim 1, wherein the first separator portion and the second separator portion are adhered to opposite sides of the single negative lithium-metal electrode.

6. The lithium-metal electrochemical cell of claim 1, wherein the single negative lithium-metal electrode comprises an outer edge, extending away from the separator and defining an unwrapped negative-electrode portion and welded to a negative tab.

7. The lithium-metal electrochemical cell of claim 6, wherein the unwrapped negative-electrode portion forms multiple independent unwrapped layers stacked along a stacking axis, welded together, and welded to the negative tab.

8. The lithium-metal electrochemical cell of claim 1, wherein the one edge wrapped by the electrode-separator integrated assembly of one of the multiple positive electrodes is positioned on opposite sides of the stack formed by the multiple positive electrodes.

9. The lithium-metal electrochemical cell of claim 1, wherein the single negative lithium-metal electrode has a uniform composition through an entire volume of the single negative lithium-metal electrode.

10. The lithium-metal electrochemical cell of claim 9, wherein the single negative lithium-metal electrode has a thickness of less than 100 micrometers.

11. An electrode-separator integrated assembly for use on a lithium-metal electrochemical cell, the electrode-separator integrated assembly comprising:
a single negative lithium-metal electrode; and
a separator comprising a first separator portion and a second separator portion, wherein the single negative lithium-metal electrode is positioned between the first separator portion and the second separator portion and adhered to each of the first separator portion and the second separator portion.

12. The electrode-separator integrated assembly of claim 11, wherein the first separator portion and the second separator portion are monolithic with each other joining together and forming a separator edge folded around an inner edge of the single negative lithium-metal electrode.

13. The electrode-separator integrated assembly of claim 11, wherein the first separator portion and the second separator portion are adhered to opposite sides of the single negative lithium-metal electrode.

14. The electrode-separator integrated assembly of claim 11, further comprising an outer edge, extending away from the separator and defining an unwrapped negative-electrode portion and welded to a negative tab.

15. A method of fabricating lithium-metal electrochemical cell, the method comprising:
positioning a single negative lithium-metal electrode between a first separator portion and a second separator portion of a separator thereby forming an electrode-separator integrated assembly; and
wrapping the electrode-separator integrated assembly through multiple positive electrodes while stacking the multiple positive electrodes along a stacking axis of the lithium-metal electrochemical cell, wherein:
each pair of two adjacent electrodes of the multiple positive electrodes has the electrode-separator integrated assembly extending between these two adjacent electrodes,
each of the multiple positive electrodes has one edge wrapped by the electrode-separator integrated assembly, and
the single negative lithium-metal electrode is separated from each of the multiple positive electrodes by the separator.

16. The method of claim 15, wherein positioning the single negative lithium-metal electrode between the first separator portion and the second separator portion comprises folding the second separator portion relative to the first separator portion thereby forming a separator edge wrapping around an inner edge of the single negative lithium-metal electrode.

17. The method of claim 15, wherein positioning the single negative lithium-metal electrode between the first separator portion and the second separator portion further comprises compressing a stack of the first separator portion, the single negative lithium-metal electrode, and the second separator portion.

18. The method of claim 15, wherein wrapping the electrode-separator integrated assembly through the multiple positive electrodes comprises:
unwinding the electrode-separator integrated assembly forming a planar portion of the electrode-separator integrated assembly;
placing one of the multiple positive electrodes onto the planar portion of the electrode-separator integrated assembly; and
folding the electrode-separator integrated assembly over a wrapped edge of the one of the multiple positive electrodes thereby forming an additional planar portion of the electrode-separator integrated assembly.

19. The method of claim 15, wherein:
the single negative lithium-metal electrode comprises an outer edge, extending away from the separator and defining an unwrapped negative-electrode portion, and
the method further comprises welding a negative tab to the unwrapped negative-electrode portion, welding positive tabs, placing a stack of the first separator portion, the single negative lithium-metal electrode, and the second separator portion into an enclosed, and filling an enclosure with liquid electrolyte and sealing.

20. The method of claim 19, wherein:
the unwrapped negative-electrode portion forms multiple independent unwrapped layers stacked along a stacking axis; and
welding the negative tab to the unwrapped negative-electrode portion comprises welding together the multiple independent unwrapped layers and welding the multiple independent unwrapped layers to the negative tab.
